(19) United States
(12) Patent Application Publication
(10) Pub. No.: US 2021/0146316 A1
(43) Pub. Date: May 20, 2021

(54) ENCAPSULATING PARTICLE FRACTIONATION DEVICES AND SYSTEMS AND METHODS OF THEIR USE

(71) Applicant: TeraPore Technologies, Inc., South San Francisco, CA (US)

(72) Inventors: Rachel M. Dorin, San Carlos, CA (US); Spencer Robbins, San Carlos, CA (US)

(21) Appl. No.: 17/045,105

(22) PCT Filed: Apr. 4, 2019
(86) PCT No.: PCT/US2019/025551

§ 371 Date: Oct. 2, 2020

Related U.S. Application Data
(60) Provisional application No. 62/652,682, filed on Apr. 4, 2018.

(51) Int. Cl. B01D 71/80; B01D 69/02; B01D 69/12

(52) U.S. Cl. CPC B01D 71/80; B01D 2325/02; B01D 69/12; B01D 69/02

(57) ABSTRACT

A method for fractionating a liquid include contacting a liquid comprising at least one type of encapsulating particle with at least one mesoporous isoporous block copolymer material, wherein at least one component of the liquid is separated. A device for fractionating a liquid having encapsulating particles includes at least one mesoporous isoporous block copolymer material. The device can further include an inlet to allow the liquid to contact the mesoporous isoporous block copolymer material, and an outlet to allow passage of the fractionated liquid. In some instances, the device can be a pleated capsule, a flat sheet cassette, a spiral wound module, a hollow fiber module, a syringe filter, a microcentrifuge tube, a centrifuge tube, a spin column, a multiple well plate, a vacuum filter, a flat sheet, or a pipette tip.

### CROSS REFERENCE TO RELATED APPLICATION

This application claims the benefit of U.S. Provisional Application No. 62/652,682, filed Apr. 4, 2018, the contents are incorporated by reference herein in their entirety.

### FIELD OF THE INVENTION

The disclosure relates to methods of using mesoporous isoporous block copolymer materials for the fractionation of liquids comprising encapsulating particles. The disclosure also relates to devices comprising mesoporous isoporous block copolymer materials for the fractionation of liquids comprising encapsulating particles

### BACKGROUND OF THE INVENTION

Encapsulating particles include, without limitation, structures such as cells, viruses, vesicles, liposomes, vacuoles, lysosomes, exosomes, and polymersomes. More generally these encapsulating particles comprise an outer barrier which encapsulates its interior contents, which can comprise gases, liquids, or solids, or any combination of gases, liquids or solids. Separating encapsulating particles from liquids is especially challenging since the particles are generally susceptible to rupture, deformation, and caking. One common strategy for separating encapsulating particles is filtration using a filter/membrane. When selecting a filter for such a separation, the membrane/filter pore size should be small enough to exclude the encapsulating particle, but large enough to prevent clogging and low volumetric flux.

Blood fractionation is a common example of separating encapsulating particles, wherein blood cells are separated from the blood plasma. Blood fractionation is used for various applications, including clinical blood analysis and the isolation of blood plasma proteins for patient care and pharmaceutical production. Separating the blood cells from the plasma is typical for many applications.

A common technique for blood fractionation, especially in clinical analysis, is centrifugation. Centrifugation requires a centrifuge, which is not practical in every environment. For example, in an automated blood analysis machine, the inclusion of a centrifuge introduces an additional component requiring maintenance and adds to cost and bulk. Centrifuges are also inconvenient in point-of-care use.

Blood filtration, a specific method of blood fractionation using a membrane/filter, exemplifies the challenges associated with separating encapsulating particles. Red blood cells have a maximum diameter of about 8 μm but can deform under pressure and pass through pores about 3 μm. When filtering whole blood with pores of about 3 μm, the red blood cells deform and become stuck in the pores, which is called pore plugging. Pore plugging causes lower flow and if pressure is increased to raise flow, the cells lyse, expelling their contents, which is undesirable. To mitigate pore plugging, smaller pores can be used, generally in the range of about 800 nm to about 2 μm. However, it is also known that decreasing the pore size causes the red blood cells to cake on the membrane surface, causing lowered flux or even complete volumetric flux loss.

Furthermore, some blood filtration methods rely on sedimentation and provide little to no driving force for the blood cells to go through the membrane. Specifically, blood samples in these methods cannot be pressurized significantly from the inlet side or subjected to vacuum from the outlet side of a blood filtration device, otherwise the pressure differential causes cell lysis. Without a driving force such as pressure or vacuum to force the blood sample to separate when in contact with the membrane, low plasma yields result since there is a large amount of plasma stuck in the membrane that cannot be pushed through and is thus lost. Furthermore, to minimize holdup volume of plasma, such sedimentation filters are often used without any sort of containment or housing, and the plasma simply wicks out the bottom of the membrane and drips into some collection vessel; this setup is inconvenient and leaves the plasma susceptible to contamination by whole blood which is sitting on top of the sheet of membrane.

Bruil et al. (Transfusion Medicine Reviews, Vol IX, No. 2, 1995 pp 145-166) and Kitagawa et al. (U.S. Pat. No. 6,241,886 B1) both indicate that a pore size (Bruil) or average hydraulic diameter (Kitagawa) which is effectively a pore size, of 3 μm allows red blood cells through the membrane. Togawa et al. (U.S. Pat. No. 7,927,810 B2) indicates that red blood cells might even pass through 2 μm pores. Kitagawa et al. indicates a lower useful hydraulic diameter of 500 nm, because blood clogs the filter below 500 nm and further causes lysis if the pressure is raised. Togawa et al. mentions pore sizes down to 50 nm, indicating that other blood components would clog the filters with pores below 50 nm; however, Togawa et al. only demonstrates pore sizes down to 200 nm. Togawa et al. further indicates that increasing porosity is detrimental as it leads to further hemolysis.

Block copolymer membranes have many broadly useful properties for filtration including: narrow pore size distributions, high pore densities, and tunable pore sizes in the 1 nm to 200 nm range. Related art teaches that the smaller pore sizes and higher pore densities associated with block copolymer membranes would worsen the filtration of encapsulating particles such as blood cells in whole blood. Surprisingly, the materials and devices of this disclosure enable blood filtration under pressure without the expected lysis of cells. To anyone skilled in the art, this improvement is beneficial for broad range of fractionation of liquid comprising encapsulated particles.

### BRIEF DESCRIPTION OF THE DRAWINGS

FIG. 1 is an illustration of an example of a mesoporous isoporous block copolymer material.

FIG. 2 is a schematic of an embodiment in accordance with various aspects of the present disclosure, wherein a liquid comprising encapsulating particles is fractionated by contact with a mesoporous isoporous block copolymer material.

FIG. 3 is a schematic of another embodiment in accordance with various aspects of the present disclosure, wherein a liquid comprising encapsulating particles is fractionated by contact with a mesoporous isoporous block copolymer material wherein the liquid is pressurized.

FIG. 4 is a schematic of yet another embodiment in accordance with various aspects of the present disclosure, wherein a liquid comprising encapsulating particles is fractionated by contact with a mesoporous isoporous block copolymer material wherein vacuum is applied to the mesoporous isoporous block copolymer material.

FIG. 5 is a schematic of yet another embodiment in accordance with various aspects of the present disclosure, wherein a liquid comprising encapsulating particles is fractionated once by contact with a mesoporous isoporous block copolymer material, then said fractionated liquid is fractionated a second time by contact with a second mesoporous isoporous block copolymer material.

FIG. 6 is a schematic of yet another embodiment in accordance with various aspects of the present disclosure, wherein a liquid comprising encapsulating particles is fractionated once by contact with a mesoporous isoporous block copolymer material wherein the liquid is pressurized, then said fractionated liquid is fractionated a second time by contact with a second mesoporous isoporous block copolymer material.

FIG. 7 is a schematic of yet another embodiment in accordance with various aspects of the present disclosure, wherein a liquid comprising encapsulating particles is fractionated once by contact with a mesoporous isoporous block copolymer material, then said fractionated liquid is fractionated a second time by contact with a second mesoporous isoporous block copolymer material wherein vacuum is applied at or near the outlet of the second mesoporous isoporous block copolymer material providing a pressure differential across both membranes.

FIG. 8 is a schematic of yet another embodiment in accordance with various aspects of the present disclosure, wherein a liquid comprising encapsulating particles is fractionated once by contact with a mesoporous isoporous block copolymer material in crossflow mode, then the permeate is fractionated a second time by contact with a second mesoporous isoporous block copolymer material in crossflow mode.

FIG. 9 is a schematic of yet another embodiment in accordance with various aspects of the present disclosure, wherein a liquid comprising encapsulating particles is fractionated once by contact with a mesoporous isoporous block copolymer material in crossflow mode, then the retentate is fractionated by contact with a second mesoporous isoporous block copolymer material in crossflow mode.

FIG. 10 is an illustration of an exemplary device in accordance with various aspects of the present disclosure.

FIG. 11 is an illustration of another exemplary device in accordance with various aspects of the present disclosure.

FIG. 12 is an illustration of yet another exemplary device in accordance with various aspects of the present disclosure.

FIG. 13 is an illustration of yet another exemplary device in accordance with various aspects of the present disclosure.

FIG. 14 is an illustration of yet another exemplary device in accordance with various aspects of the present disclosure.

FIG. 15 is an illustration of yet another exemplary device in accordance with various aspects of the present disclosure.

FIG. 16 is an illustration of yet another exemplary device in accordance with various aspects of the present disclosure.

FIG. 17 is an illustration of yet another exemplary device in accordance with various aspects of the present disclosure.

FIG. 18 is an illustration of yet another exemplary device in accordance with various aspects of the present disclosure.

FIG. 19 is an illustration of yet another exemplary device in accordance with various aspects of the present disclosure.

FIG. 20 is UV-Visible spectra of a diluted whole blood solution (A, dashed) and a diluted permeate after filtration through a mesoporous isoporous block copolymer material (B, solid black).

FIG. 21 is optical microscopy images of whole blood showing blood cells (A, left), compared with permeate notably absent of color or blood cells after filtration through a mesoporous isoporous block copolymer material (B, right).

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively 5 percent, and alternatively ±1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be nonlimiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The present disclosure relates to a device comprising at least one mesoporous isoporous block copolymer material for fractionating a liquid comprising encapsulating particles. The present disclosure also relates to a method for fractionating a liquid comprising encapsulating particles using at least one mesoporous isoporous block copolymer material.

In the context of the disclosure, “isoporous” means having a substantially narrow pore diameter distribution.

In the context of the disclosure, “mesoporous” means having pore diameters of about 1 to about 200 nanometers.

In the context of the present disclosure, an “encapsulating particle” means a particle comprising an outer barrier which encapsulates its interior contents; the interior contents can comprise gases, liquids, or solids, or any combination of gases, liquids or solids.

In the context of the disclosure, a “selective portion” of a mesoporous isoporous block copolymer material can be defined as a portion of material comprising porosity. In the context of the disclosure, the “most selective portion” of a mesoporous isoporous block copolymer material can be defined as a selective portion of the material comprising the smallest average pore diameter. In the context of the disclosure, the “least selective portion” of a mesoporous isoporous block copolymer material can be defined as a selective portion of the material comprising the largest average pore diameter.

In the context of the disclosure, “retentate” means the liquid that does not pass through the porous material.

In the context of the disclosure, “permeate” means the liquid that passes through the porous material.

In accordance with various aspects of the present disclosure, a mesoporous isoporous block copolymer material can have mesopores with diameters ranging from about 1 nm to about 200 nm. In some instances, the mesopores can range from about 3 nm to about 200 nm in diameter. In other instances, the mesopores can range from about 5 nm to about 200 nm in diameter. In yet other instances, the mesopores can range from about 5 nm to about 100 nm in diameter. In yet other instances, the mesopores can range from about 10 nm to about 100 nm in diameter. In yet other instances, the mesopores can range from about 5 nm to about 49 nm in diameter. In yet other instances, the mesopores can range from about 20 nm to about 49 nm in diameter. In yet other instances, the mesopores can range from about 1 nm to about 49 nm in diameter. In yet other instances, the mesopores can range from about 5 nm to about 50 nm in diameter. In yet other instances, the mesopores can range from about 5 nm to about 15 nm in diameter.

Block copolymer membranes have many useful properties for filtration including narrow pore size distributions (isoporosity), high pore densities, and tunable pore sizes in the about 1 nm to about 200 nm range.

In some embodiments, the most selective layer of at least one mesoporous isoporous block copolymer material faces the incoming liquid comprising encapsulating particles and the most selective layer's average pore diameters are significantly smaller than the maximum diameter of at least one of the encapsulating particles. In the context of these embodiments, relative diameters can be defined through a ratio, denoted lambda (λ), of the encapsulating particle's maximum diameter (d_{PART}) relative to the average pore diameter (d_{PORE}) of the mesoporous isoporous block copolymer material, where λ=d_{PART}/d_{PORE}. In at least one embodiment, λ is at least about 40. In some instances, λ is at least 100. In other instances, λ is at least about 150. In yet other instances, λ is at least about 200. In yet other instances, λ is at least about 300. In yet other instances, λ is at least about 350. In yet other instances, λ is at least about 375. In yet other instances, λ is at least about 400. In yet other instances, λ is at least about 500. In yet other instances, λ is at least about 600. In yet other instances, λ is at least about 700. In yet other instances, λ is at least about 800. In yet other instances, a is at least about 850. In yet other instances, λ is at least about 900. In an embodiment, λ is at least about 1000. In yet other instances, is at least about 1500. In yet other instances, λ is at least about 15000. In some embodiments, λ is at most 30,000. In an instance, λ is at most 25,000. In another instance, λ is at most 20,000. In yet another instance, λ is at most 18,000. Examples in accordance with the present disclosure are found in Table 1.

TABLE 1
Examples of λ of various embodiments according to the disclosure

| Example Encapsulating Particles | d_{PART} (nm) | d_{PORE} (nm) | λ |
|---|---|---|---|
| Red blood cells | 8000 | 1 | 8000 |
| White blood cells | 17000 | 1 | 17000 |
| Red blood cells | 8000 | 20 | 400 |
| White blood cells | 17000 | 20 | 850 |
| Red blood cells | 8000 | 50 | 160 |
| White blood cells | 17000 | 50 | 340 |
| Red blood cells | 8000 | 100 | 80 |
| White blood cells | 17000 | 100 | 170 |
| Red blood cells | 8000 | 200 | 40 |
| White blood cells | 17000 | 200 | 85 |

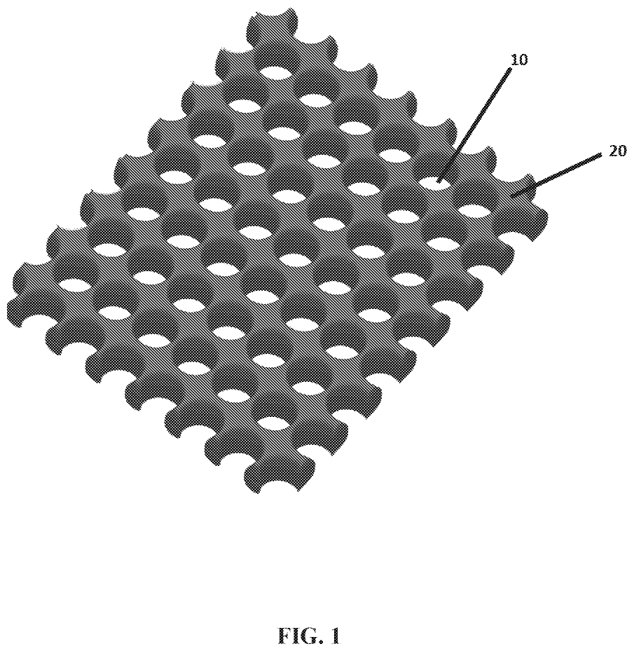

In some embodiments, for example as depicted in FIG. 1, the mesoporous isoporous block copolymer material is a two-dimensional (e.g. sheet, film) or three-dimensional structure (e.g. tube, monolith) and comprises material comprising block copolymer 20, and mesopores 10. The mesoporous isoporous block copolymer material can be asymmetric or symmetric in cross-sectional structure. For the purposes of this disclosure, and as commonly defined in the filtration industry, asymmetric membrane is one with pore structure that is uniform through its thickness while an asymmetric membrane is one with a pore structure that varies through the thickness.

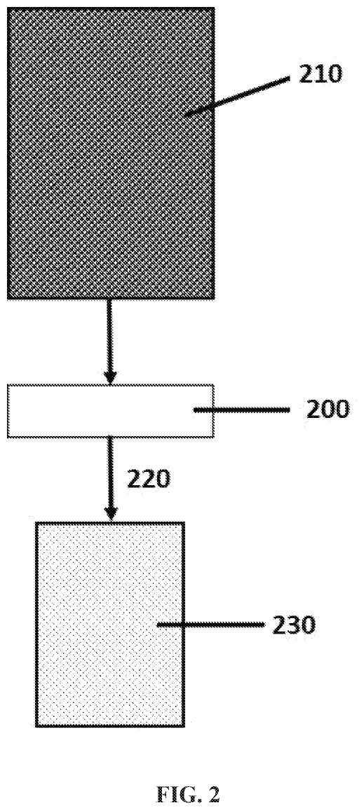

In at least one embodiment, for example as depicted in FIG. 2, at least one mesoporous isoporous block copolymer material 200, is contacted with a liquid comprising encapsulating particles 210, causing at least one component of the liquid to be separated or removed, and a permeate 220, is collected as a once fractionated liquid 230.

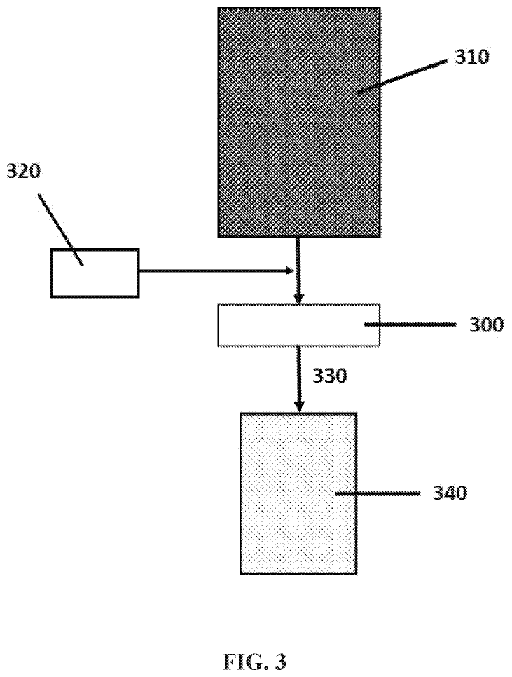

In some embodiments, for example as depicted in FIG. 3, at least one mesoporous isoporous block copolymer material 300 is contacted with a liquid comprising encapsulating particles 310 and a pressure differential is applied across the mesoporous isoporous block copolymer material 300 using a pressurization source 320, causing at least one component of the liquid to be separated or removed, and a permeate 330 is collected as a once fractionated liquid 50.

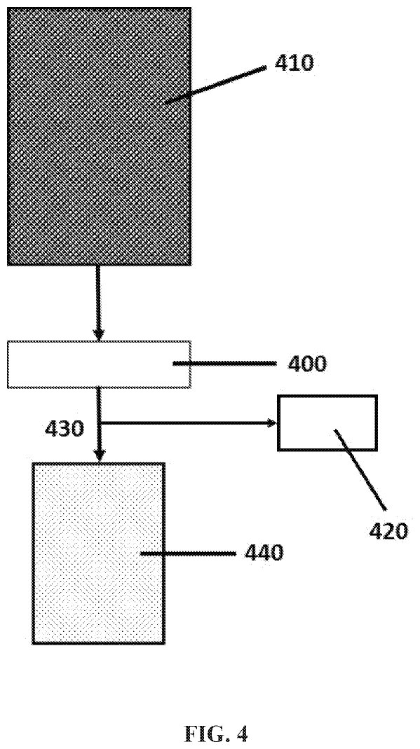

In some embodiments, for example as depicted in FIG. 4, at least one mesoporous isoporous block copolymer material 400 is contacted with a liquid comprising encapsulating particles 410 and a pressure differential is applied across the mesoporous isoporous block copolymer material 400 using a vacuum source 420, causing at least one component of the liquid to be separated or removed, and a permeate 430 is collected as a once fractionated liquid 440.

In some embodiments, at least one mesoporous isoporous block copolymer material is contacted with a liquid comprising encapsulating particles, and a variable or intermittent pressure differential is applied across the mesoporous isoporous block copolymer material, causing at least one component of the liquid to be separated or removed. A variable or intermittent pressure differential can serve to disrupt any buildup at the surface.

In at least one embodiment, at least one mesoporous isoporous block copolymer material, wherein the cross-sectional structure of the mesoporous isoporous block copolymer material is symmetric, is contacted with a liquid comprising encapsulating particles, causing at least one component of the liquid to be separated or removed.

In at least one embodiment, at least one mesoporous isoporous block copolymer material, wherein the cross-sectional structure of the mesoporous isoporous block copolymer material is asymmetric, is contacted with a liquid comprising encapsulating particles, causing at least one component of the liquid to be separated or removed.

In at least one embodiment, at least one mesoporous isoporous block copolymer material, wherein the cross-sectional structure of the mesoporous isoporous block copolymer material is asymmetric, is contacted with a liquid comprising encapsulating particles, wherein the liquid contacts the most selective portion of the mesoporous isoporous block copolymer material first, causing at least one component of the liquid to be separated or removed.

In at least one embodiment, a device in accordance with various aspects of the present disclosure comprises at least one mesoporous isoporous block copolymer material.

In at least one embodiment, a device in accordance with various aspects of the present disclosure comprises at least one mesoporous isoporous block copolymer material, an inlet to allow said liquid to contact said mesoporous isoporous block copolymer material, and an outlet to allow passage of the fractionated liquid.

In at least one embodiment, a device in accordance with various aspects of the present disclosure comprises at least one mesoporous isoporous block copolymer material, an inlet to allow said liquid to contact said mesoporous isoporous block copolymer material, an outlet to allow passage of the fractionated liquid, and a vent to remove gas from the device.

In at least one embodiment, a device in accordance with various aspects of the present disclosure comprises at least one mesoporous isoporous block copolymer material, an inlet to allow said liquid to contact said mesoporous isoporous block copolymer material, an outlet to allow passage of the fractionated liquid, and a retentate outlet to remove unfiltered liquid.

In at least one embodiment, a device in accordance with various aspects of the present disclosure comprises at least one mesoporous isoporous block copolymer material, an inlet to allow said liquid to contact said mesoporous isoporous block copolymer material, an outlet to allow passage of the fractionated liquid, and a receiving vessel to capture fractionated liquid.

In at least one embodiment, a device in accordance with various aspects of the present disclosure comprises at least one mesoporous isoporous block copolymer material, an inlet to allow said liquid to contact said mesoporous isoporous block copolymer material, an outlet to allow passage of the fractionated liquid and at least two of the following: a vent to remove gas from the device, a retentate outlet to remove unfiltered liquid, and a receiving vessel to capture fractionated liquid.

In at least one embodiment, a device in accordance with various aspects of the present disclosure comprises at least one mesoporous isoporous block copolymer material, an inlet to allow said liquid to contact said mesoporous isoporous block copolymer material, an outlet to allow passage of the fractionated liquid, a vent to remove gas from the device, a retentate outlet to remove unfiltered liquid, and a receiving vessel to capture fractionated liquid.

In some embodiments, a device in accordance with various aspects of the present disclosure comprises at least one mesoporous isoporous block copolymer material comprising an asymmetric cross-section wherein the most selective mesoporous portion of at least the first mesoporous isoporous block copolymer material faces the inlet such that any incoming liquid contacts the most selective portion of said mesoporous isoporous material first.

In some embodiments, a device in accordance with various aspects of the present disclosure comprises an inlet and the inlet can be part of a housing for a mesoporous isoporous block copolymer material. For example, in at least one embodiment the inlet can be a molded plastic part of a syringe filter. In other embodiments, the inlet can simply be the exposed surface of a mesoporous isoporous block copolymer material wherein liquid can be introduced to contact a mesoporous isoporous block copolymer material. For example, in at least one embodiment the inlet can be the most selective portion of a mesoporous isoporous block copolymer material wherein the mesoporous isoporous block copolymer material is a flat sheet membrane.

In some embodiments, a device in accordance with various aspects of the present disclosure comprises an outlet and the outlet can be part of a housing for a mesoporous isoporous block copolymer material. For example, in at least one embodiment the outlet can be a plastic part of a hollow fiber module. In other embodiments, the outlet can simply be the exposed surface of a mesoporous isoporous block copolymer material wherein liquid can exit a mesoporous isoporous block copolymer material. For example, in at least one embodiment the outlet can be the least selective portion of a mesoporous isoporous block copolymer material wherein the mesoporous isoporous block copolymer material is a flat sheet membrane attached to the bottom of a multiple well plate.

In some embodiments, a device in accordance with various aspects of the present disclosure comprises a vent for removing gas from the device as or after a liquid is introduced. In at least one embodiment, the vent can be an opening that can be opened or closed. For example, in at least one embodiment, the vent is a valve incorporated into a housing that can be manually or remotely actuated to transition between an open state, partially open state, or closed state. In at least one embodiment, the vent is a molded part of a housing that has a removable cap, cover, or fitting allowing for opening, partial opening, and closing. In at least one embodiment, the vent is an opening or connection where an external valve, fitting, connector, cover, or cap can be connected, and used to meter the vent between an open state and a closed state.

In some embodiments, a device in accordance with various aspects of the present disclosure comprises a receiving vessel to capture fractionated liquid. In some embodiments, the receiving vessel is an integrated portion of the device. In some embodiments, the receiving vessel is a removable portion of the device.

In at least one embodiment, at least one mesoporous isoporous block copolymer material, wherein the cross-sectional structure of the mesoporous isoporous block copolymer material is asymmetric, is contacted with a liquid comprising encapsulating particles, wherein the liquid contacts the most selective portion of the mesoporous isoporous block copolymer material first and a pressure differential is applied across the mesoporous isoporous block copolymer material, causing at least one component of the liquid to be separated or removed. Pressurization can be applied, for example, by manual or mechanical actuation of a plunger as found, for example, on a syringe. Pressurization can also be applied, for example, by a gas or a liquid driven from a pump or a pressurized container of said gas or liquid.

In at least one embodiment, at least one mesoporous isoporous block copolymer material is contacted with a liquid comprising encapsulating particles, wherein at least one component is separated or removed, with or without a pressure differential applied across the mesoporous isoporous block copolymer material, while minimizing lysis of the encapsulating particles. In one instance, encapsulating particle lysis is less than about 1% of particles lysed. In another instance, encapsulating particle lysis is less than about 5% of particles lysed. In yet another instance, encapsulating particle lysis is less than about 10% of particles lysed. Vacuum can be applied, for example, by drawing down a plunger manually or mechanically on, for example, a syringe. Vacuum can also be applied, for example, from a vacuum pump. In some embodiments, the vacuum is applied directly from the device outlet. For example, a syringe can be connected to the device outlet and drawn back to apply vacuum. In some instances, a splitter can be included on the outlet to allow for vacuum application on one port and liquid collection through another port. One example of such an embodiment is a vacuum filtration device wherein the vacuum connection is above the device outlet, encapsulated by a receiving vessel. In this example, vacuum aids the fractionation, but since the outlet is below the vacuum source, the fractionated liquid can be collected without being sucked directly into the vacuum source.

In at least one embodiment, at least one mesoporous isoporous block copolymer material is contacted with whole blood, wherein at least one component of the whole blood is separated or removed.

In at least one embodiment, at least one mesoporous isoporous block copolymer material is contacted with a liquid comprising whole blood, wherein at least one component of the whole blood is separated or removed.

In at least one embodiment, at least one mesoporous isoporous block copolymer material is contacted with a liquid comprising at least one type of blood cell, wherein the at least one type of blood cell is separated or removed.

In at least one embodiment, at least one mesoporous isoporous block copolymer material is contacted with a liquid comprising blood and further comprising at least one preservative including but not limited to EDTA, an oxalate salt, sodium citrate, sodium iodoacetate, sodium fluoride, and heparin, causing at least one component of the blood to be separated or removed.

In at least one embodiment, at least one mesoporous isoporous block copolymer material is imbibed with at least one preservative including but not limited to EDTA, an oxalate salt, sodium citrate, sodium iodoacetate, sodium fluoride, and heparin.

In some embodiments, the mesoporous isoporous block copolymer material is packaged as or in a device including, for example: a pleated pack, one or more flat sheets in a cassette, a spiral wound module, hollow fibers, a hollow fiber module, a syringe filter, a microcentrifuge tube, a centrifuge tube, a spin column, a multiple well plate, a vacuum filter, or a pipette tip. In an embodiment, such a device can utilize more than one different material of the disclosure.

In some embodiments, at least one component that is separated or removed from the liquid comprising encapsulating particles is collected or recovered after contacting the mesoporous isoporous block copolymer.

In some embodiments, more than one mesoporous isoporous block copolymer material or device comprising mesoporous isoporous material is used during the fractionation of the liquid comprising one or more sizes of encapsulating particles. In an embodiment as depicted in FIG. 5 for example, a liquid comprising encapsulating particles 500 is contacted with a mesoporous isoporous block copolymer material 510, and a permeate 520 is collected as a once fractionated liquid 530. The once fractionated liquid 530 is subsequently contacted with a second mesoporous isoporous material 540, and a permeate 550 is collected as a twice fractionated liquid 560.

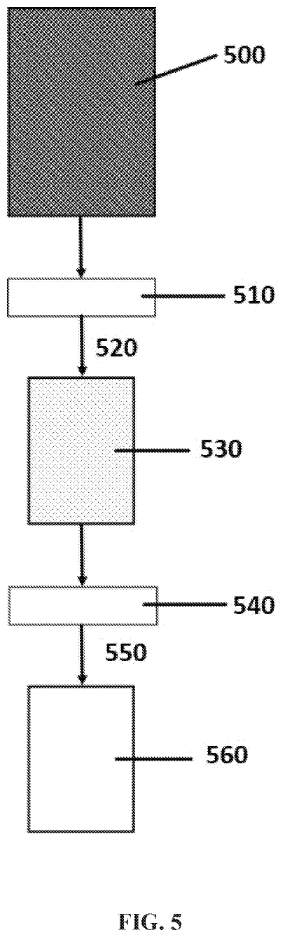

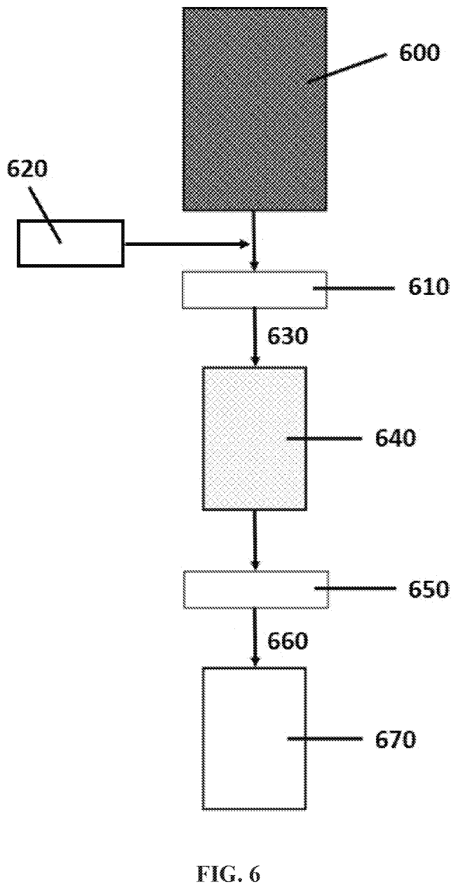

In an embodiment as depicted in FIG. 6 for example, a liquid comprising encapsulating particles 600 is contacted with a mesoporous isoporous block copolymer material 610 and pressurized using a pressurization source 620, and a first permeate 630 is collected as a once fractionated liquid 640. The once fractionated liquid 640 is subsequently contacted with a second mesoporous isoporous material 650, and a second permeate 660 is collected as a twice fractionated liquid 670.

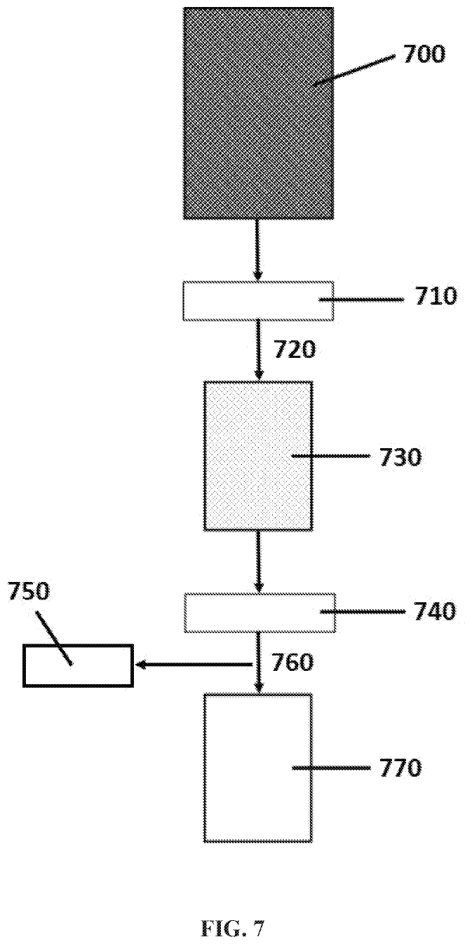

In an embodiment as depicted in FIG. 7 for example, a liquid comprising encapsulating particles 700 is contacted with a mesoporous isoporous block copolymer material 710, and a first permeate 720 is collected as a once fractionated liquid 730. The once fractionated liquid 730 is subsequently contacted with a second mesoporous isoporous material 740, and vacuum is applied across the membrane using a vacuum source 760. A second permeate 770 is collected as a twice fractionated liquid 780.

In an example of an embodiment, a syringe filter device comprising mesoporous isoporous block copolymer material is contacted with a liquid comprising encapsulating particles and a pressure gradient is applied across the syringe filter device, facilitating the separation of larger particles. Subsequently, the permeate is contacted with a surface functionalized monolithic mesoporous isoporous block copolymer material packaged in a pipette tip and a pressure differential is applied across the mesoporous isoporous block copolymer material, facilitating the separation of some of the smaller particles. Finally, the retained blood proteins can be recovered from the mesoporous isoporous block copolymer material.

In some embodiments, at least one mesoporous isoporous block copolymer material or device comprising mesoporous isoporous block copolymer material is operated in crossflow or tangential flow mode, wherein the liquid comprising encapsulating particles is passed tangential to the mesoporous isoporous selective portion of the material. In some such embodiments, more than one mesoporous isoporous block copolymer material or device comprising mesoporous isoporous block copolymer material is used for the separation of the liquid comprising encapsulating materials.

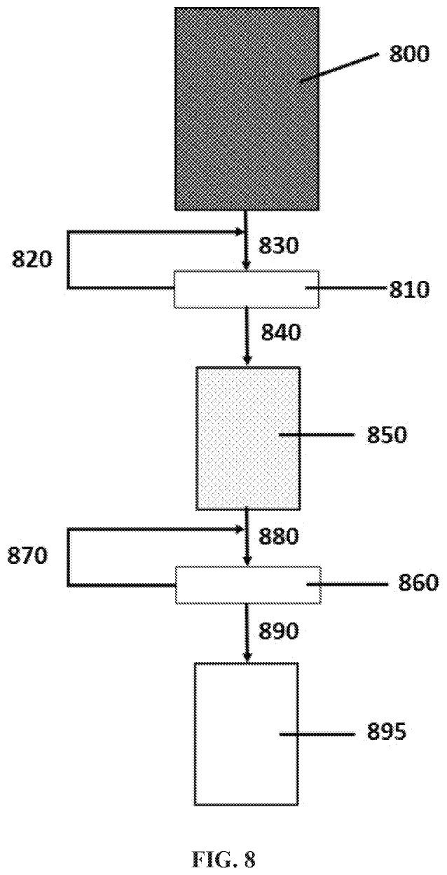

In an embodiment, as depicted in FIG. 8 for example, a liquid comprising encapsulating particles 800 is first separated by contacting a first mesoporous isoporous block copolymer material 810 in crossflow mode, where a first retentate 820 is cycled back into a first feed 830 and a first permeate 840 from the first separation is collected as a once fractionated liquid 850. The once fractionated liquid 850 is then contacted with a second mesoporous isoporous block copolymer material 860 in crossflow mode, where a second retentate 870 is cycled back into a second feed 880 and a second permeate 890 from the second separation is collected as a twice fractionated liquid 895.

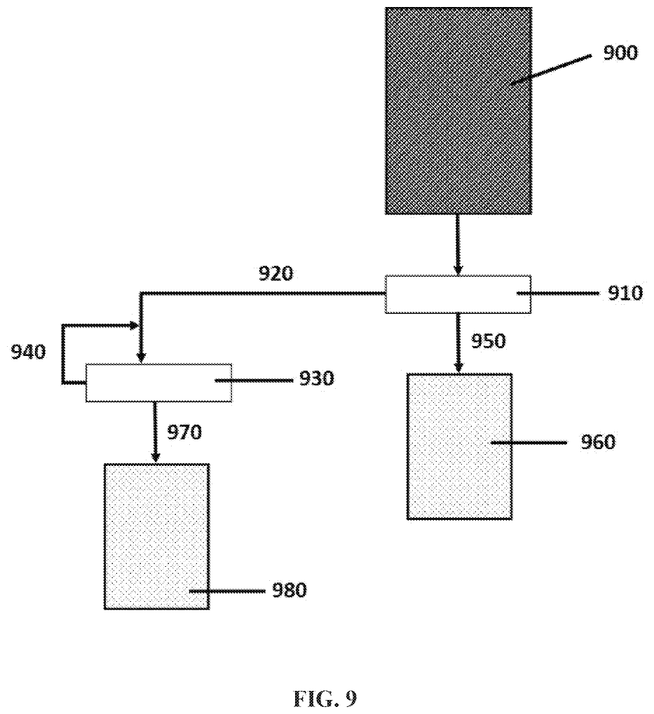

In an embodiment, as depicted in FIG. 9 for example, a liquid comprising encapsulating particles 900, is first separated by contacting a first mesoporous isoporous block copolymer material 910 in crossflow mode, where a first retentate 920 is further separated by a second mesoporous isoporous block copolymer material 930 in crossflow mode where a second retentate 940 can optionally be cycled back into a feed of the first retentate 920. A first permeate 950, obtained from the first separation using the first mesoporous isoporous block copolymer material 910, is collected as a once fractionated liquid 960. A second permeate 970, obtained from further separation of the first retentate 920, and optionally the second retentate 940, using the second mesoporous isoporous block copolymer material 930, is also collected as a fractionated liquid 980. In another exemplary embodiment, a liquid comprising encapsulating particles is first separated by a mesoporous isoporous block copolymer material in crossflow mode, and secondly, the retentate from the first separation is then contacted with a second mesoporous isoporous block copolymer material in crossflow mode for further separation.

In some embodiments, at least one mesoporous isoporous block copolymer material comprises a diblock copolymer.

In some embodiments, at least one mesoporous isoporous block copolymer material comprises a triblock copolymer. In one such embodiment, at least one mesoporous isoporous block copolymer material comprises an A-B-A triblock copolymer. In one such embodiment, at least one mesoporous isoporous block copolymer material comprises an A-B-C triblock copolymer. Any block architecture, so long as the material is mesoporous and isoporous and comprises at least one block copolymer, is suitable.

In some embodiments, at least one mesoporous isoporous block copolymer material comprises a tetrablock or higher order copolymer, e.g. pentablock, heptablock, etc. Any block architecture, so long as the material is mesoporous and isoporous and comprises at least one block copolymer, is suitable, for example, A-B-A-B, A-B-C-A, A-B-C-B, A-B-C-D, A-B-C-D-E, A-B-A-C-D-E, A-B-A-B-A-B-A, A-B-C-A-B-A-C-D, etc.

Some examples of suitable block chemistries include, but are not limited to: Poly(isobutylene), Poly(isoprene), Poly(butadiene), Poly(propylene glycol), Poly(ethylene oxide), Poly(dimethylsiloxane), Poly(ethersulfone), Poly(sulfone), Poly(hydroxystyrene), Poly(methylstyrene), Poly(ethylene glycol), Poly(2-hydroxyethyl methacrylate), Poly(acrylamide), Poly(N,N-dimethylacrylamide), Poly(propylene oxide), Poly(styrene sulfonate), Poly(styrene), Poly(ethylene), Poly(vinyl chloride), Poly(2-(perfluorohexyl)ethyl methacrylate), Poly(tetrafluoroethylene), Poly(vinylidene fluoride), Poly(pentafluorostyrene), Poly(acrylic acid), Poly(2-vinylpyridine), Poly(4-vinylpyridine), Poly(3-vinylpyridine), Poly(N-isopropylacrylamide), Poly(dimethylaminoethyl methacrylate), Poly(glycidyl methacrylate), Poly(ethyleneimine), Poly(lactic acid), Poly(acrylonitrile), Poly(methyl acrylate), Poly(butyl methacrylate), Poly(methyl methacrylate), Poly(n-butyl acrylate), Poly(amic acid), Poly(isocyanate), Poly(ethyl cyanoacrylate), Poly(allylamine hydrochloride), or a substituted equivalent of any of the above.

In some instances, suitable mesoporous isoporous block copolymer materials include those with Mₙ of about 1×10³ to about 1×10⁷ g/mol and include diblock, triblock, or multiblock copolymers of higher order (i.e., tetrablock, pentablock, etc.). Polydispersity index (PDI) of a block copolymer is the measure of heterogeneity of the size of molecules and shows the distribution of molar mass in the block copolymer sample. It is the ratio of average molar mass (M_{w}) and number-average molar mass (Mₙ). The PDI of at least one embodiment of a BCP disclosed herein is in the range of about 1.0 to about 3.0.

In some embodiments, suitable mesoporous isoporous block copolymer materials comprise at least one diblock copolymer or multiblock copolymer, having a structure in the form of A-B, B-A, B-A-B, A-B-A-B, B-A-B-A, or A-B-A, wherein A and B represent two distinct types of block chemistries. In a preferable embodiment, A is a hydrophilic and/or hydrogen-bonding block and B is a hydrophobic block. Suitable hydrogen-bonding and/or hydrophilic blocks include, but are not limited to, polyvinylpyridines, polyethylene oxides, polyacrylic acids, poly(hydroxystyrene), polyacrylates and polymethacrylates, substituted polyacrylates and polymethacrylates. More specific examples of hydrophilic blocks include: poly(acrylic acid), poly(acrylamide), poly(vinylpyridine), poly(vinylpyrrolidone), poly(vinyl alcohol), naturally derived polymers such as cellulose and chitosan, poly(ether), poly(maleic anhydride), poly(N-isopropylacrylamide), poly(styrene sulfonate), poly(allylhydrochloride), poly(sulfone), poly(ethersulfone), poly(ethylene glycol), poly(2-hydroxyethyl methacrylate). More specific examples of hydrogen-bonding blocks include: poly(vinylpyridine), poly(ethylene oxide), poly(methacrylate), poly(methyl methacrylate), poly(dimethylethyl amino ethyl methacrylate), poly(dimethylaminoethyl methacrylate) poly(acrylic acid), poly(hydroxystyrene), poly(dimethylacrylamide). Suitable hydrophobic blocks can include, but are not limited to, polystyrenes, e.g., polystyrene and poly(alkyl substituted styrene) such as poly(alpha-methyl styrene), polypropylenes, poly(vinyl chlorides), polybutadiene, poly(isoprene), poly(ethylene-stat-butylene), poly(ethylene-alt-propylene), and polytetrafluoroethylenes. Furthermore, substituted analogues of the above are suitable.

In some embodiments, at least one mesoporous isoporous block copolymer material comprises a complex architecture. In this context, a “complex” block structure or polymer architecture signifies more than one monomer, chemistry, configuration, or structure in at least one block, or adjacent to blocks. A combination of different block copolymer starting materials is another complex architecture of the disclosure. Nonlimiting examples of complex architecture include: gradient blocks, mixtures of monomers in blocks, cyclic blocks or overall cyclic structures, branched blocks, dendritic structures, mixtures of block copolymers, etc. Any block architecture, complex or not, is suitable, so long as the material is mesoporous and isoporous and comprises at least one block copolymer.

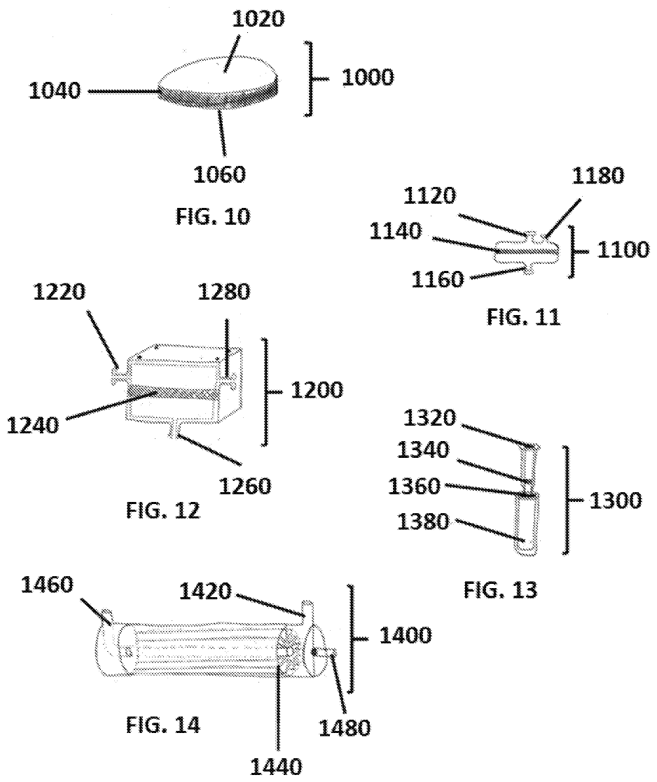

In some instances, a device in accordance with various aspects of the present disclosure can be, for example, a flat sheet 1000 having an inlet 1020, a block copolymer material 1040, and an outlet 190; a configuration of such a device can be as illustrated in FIG. 10.

In some instances, a device in accordance with various aspects of the present disclosure can be, for example, a syringe filter 1100 having an inlet 1120, a block copolymer material 1140, an outlet 1160, and a vent 1180; a configuration of such a device can be as illustrated in FIG. 11.

In some instances, a device in accordance with various aspects of the present disclosure can be, for example, a crossflow module 1200 having an inlet 1220, a block copolymer material 1240, an outlet 1260, and a retentate port 1280; a configuration of such a device can be as illustrated in FIG. 12.

In some instances, a device in accordance with various aspects of the present disclosure device can be, for example, a spin column 1300 having an inlet 1320, a block copolymer material 1340, an outlet 1360, and a receiving vessel 1380; a configuration of such a device can be as illustrated in FIG. 13.

In some instances, a device in accordance with various aspects of the present disclosure can be, for example, and a pleated capsule 1400 having an inlet 1420, a block copolymer material 1440, an outlet 1460, and a vent 1480; a configuration of such a device can be as illustrated in FIG. 14.

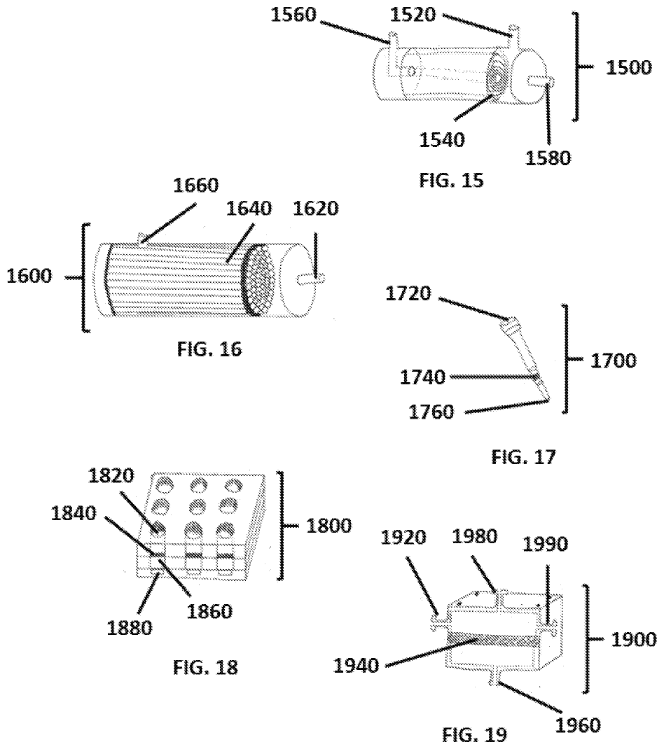

In some instances, a device in accordance with various aspects of the present disclosure can be, for example, a spiral wound module 1500 having an inlet 1520, a block copolymer material 1540, and an outlet 1560, and a vent or retentate port 1580; a configuration of such a device can be as illustrated in FIG. 15.

In some instances, a device in accordance with various aspects of the present disclosure can be, for example, a hollow fiber module 1600 having an inlet 1620, a block copolymer material 1640, and an outlet 1660; a configuration of such a device can be as illustrated in FIG. 16.

In some instances, the device can be, for example, a pipette tip 1700 having an inlet 1720, a block copolymer material 1740, and an outlet 1780; a configuration of such a device can be as illustrated in FIG. 17.

In some instances, a device in accordance with various aspects of the present disclosure can be, for example, a multiple well plate 1800, having an inlet 1820, a block copolymer material 1840, an outlet 1860, and a receiving vessel 1880; a configuration of such a device can be as illustrated in FIG. 18.

In some instances, the device can be, for example, a crossflow module 1900 having an inlet 1920, a block copolymer material 1940, an outlet 1960, and a vent 1980 and retentate port 1990; a configuration of such a device can be as illustrated in FIG. 19.

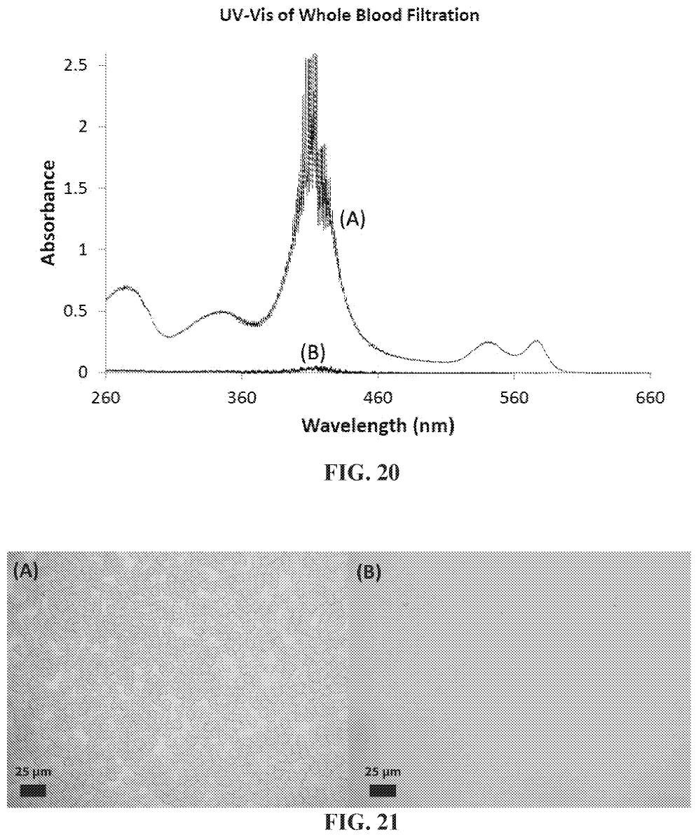

Example of the disclosure. In an example of an embodiment, mesoporous isoporous material comprising the block copolymer poly(isoprene)-block-poly(styrene)-block-poly(4-vinylpyridine) is used to fractionate a liquid comprising blood. The material is a disc of 0.7 cm² active area, of a film with an asymmetric cross-sectional structure. The pores on the side of the disc with the most selective pores are about 20 nm in diameter and this is the most selective portion. The side of the membrane in this example that is the most selective portion contacts the liquid comprising blood first. The liquid is a 1:6 dilution of whole blood in 10 mM PBS buffer. The liquid is loaded in a syringe and pressurized by hand. A nearly colorless permeate is recovered. The stock and permeate are equivalently diluted for UV-Visible spectra measurement, due to the multiple strong UV-Visible absorptions of blood components. FIG. 20 shows the UV-Visible spectra of the diluted stock (FIG. 20A, dashed line) and diluted permeate (FIG. 20B, solid line). Notable in the spectra is the near-complete removal of all absorbing species including red blood cells and their visibly absorbing compounds, as well as protein absorption at 280 nm, upon filtration by an isoporous mesoporous block copolymer material. The maximum absorption of the residual visibly absorbing species (around 400 nm) in the permeate is less than 1% of the absorption max relative to the diluted whole blood stock, and is attributed to a very small amount of red blood cell lysis, causing release of the colored compounds. As shown in FIG. 21, the diluted whole blood (FIG. 21A, left) shows blood cells throughout the view, while the undiluted permeate (FIG. 21B, right) shows no red blood cells and appears colorless. When major hemolysis occurs, for example aggressively freezing blood, the liquid appears bright red under the light microscope, even if intact red blood cells are not observed, and the image is much darker than what is observed in FIG. 21B. Minimal hemolysis despite pressurization is surprising, and a benefit over current blood filters. Enabling a pressure differential through pressurization of the feed, or relatedly, applying vacuum on the outlet, allows for minimal holdup volume and maximum processing speed thus, increasing production capacity and fractionation yields.

Table of Selected Features

| | |
|---|---|
| 10 | Mesopores, void |
| 20 | Material comprising block copolymer |
| 30 | Mesoporous isoporous material or device |
| | comprising block copolymer or device |
| 40 | Liquid comprising encapsulating particles |
| 50 | Once fractionated liquid |
| 60 | Pressurization |
| 70 | Vacuum |
| 75 | Potentate |
| 76 | Permeate |
| 80 | Twice fractionated liquid |
| 90 | Flat sheet |
| 100 | Flat Sheet Cassette |
| 110 | Syringe filter device |
| 120 | Pleated pack device |
| 130 | Spin column device |
| 140 | Spiral wound module |
| 150 | Pipette tip |
| 160 | Hollow fiber module |
| 170 | Multiple well plate |
| 180 | Inlet |
| 190 | Outlet |
| 200 | Vent |
| 210 | Retentate port |
| 220 | Receiving vessel |

What is claimed is:

1. A method for fractionating a liquid, the method comprising:
contacting a liquid comprising at least one type of encapsulating particle with at least one mesoporous isoporous block copolymer material wherein at least one component of the liquid is separated.

2. The method of claim 1, wherein at least one component of the liquid is separated, wherein a ratio (λ) of the maximum diameter of the encapsulating particle to the average pore diameter of the mesoporous isoporous block copolymer material is at least 40.

3. The method of claim 1, wherein the mesoporous isoporous block copolymer material comprises an asymmetric cross-sectional structure.

4. The method of claim 1, wherein a pressure differential is applied across the mesoporous isoporous block copolymer material to facilitate fractionation of the liquid.

5. The method of claim 1, wherein the cross-sectional structure of the mesoporous isoporous block copolymer material is asymmetric and the most selective portion of the material contacts the liquid comprising encapsulating particles.

6. The method of claim 1, wherein the liquid comprises encapsulating particles and there is minimal particle lysis during or after fractionation of the liquid.

7. The method of claim 1, wherein at least one mesoporous isoporous block copolymer material is packaged in or as a device, including for example: a pleated pack, one or more flat sheets in a cassette, a spiral wound module, hollow fibers, a hollow fiber module, a syringe filter, a microcentrifuge tube, a centrifuge tube, a spin column, a multiple well plate, a vacuum filter, or a pipette tip.

8. The method of claim 1, wherein more than one mesoporous isoporous block copolymer material or device comprising at least one mesoporous isoporous material is used during the fractionation of the liquid comprising encapsulating particles.

9. The method of claim 1, wherein at least one mesoporous isoporous block copolymer material comprises at least one diblock copolymer.

10. The method of claim 1, wherein at least one mesoporous isoporous block copolymer material comprises at least one triblock copolymer.

11. The method of claim 1, wherein at least one mesoporous isoporous block copolymer material comprises at least one higher order block copolymer, including for example: tetrablock, pentablock, heptablock, decablock, etc.

12. The method of claim 1, wherein at least one mesoporous isoporous block copolymer material comprises a complex architecture.

13. The method of claim 1 wherein at least one component that is separated or removed from the liquid comprising encapsulating particles after contacting the mesoporous isoporous block copolymer is collected or recovered.

14. The method of claim 1 wherein at least one mesoporous isoporous block copolymer material is contacted with liquid comprising encapsulating particles and further comprising at least one preservative.

15. The method of claim 1 wherein the mesoporous isoporous block copolymer material is a two-dimensional or three-dimensional structure.

16. A device for fractionating a liquid comprising encapsulating particles, the device comprising at least one mesoporous isoporous block copolymer material.

17. The device of claim 16 comprising:
a. at least one mesoporous isoporous block copolymer material,
b. an inlet to allow said liquid to contact said mesoporous isoporous block copolymer material, and
c. an outlet to allow passage of the fractionated liquid.

18. The device of claim 16, wherein the device is any one of a pleated capsule, a flat sheet cassette, a spiral wound module, a hollow fiber module, a syringe filter, a microcentrifuge tube, a centrifuge tube, a spin column, a multiple well plate, a vacuum filter, a flat sheet, or a pipette tip.

19. The device of claim 16, wherein the at least one mesoporous isoporous block copolymer material comprising an asymmetric cross-section wherein the most selective mesoporous portion of at least the first mesoporous isoporous block copolymer material faces the inlet such that any incoming liquid contacts the most selective portion of said mesoporous isoporous material first.
